(19) United States
(12) Patent Application Publication
(10) Pub. No.: US 2004/0112273 A1
(43) Pub. Date: Jun. 17, 2004

(54) Filter clogging detector

(76) Inventors: Aubrey R. Thoede, Houston, TX (US); Steven R. Eatough, Provo, UT (US); Jon S. Heaton, Provo, UT (US); Craig N. Eatough, Provo, UT (US)

Correspondence Address: BRACEWELL & PATTERSON, L.L.P., Attention: James E. Bradley, P.O. Box 61389, Houston, TX, 77208-1389, US

(21) Appl. No.: 10/651,118

(22) Filed: Aug. 28, 2003

Related U.S. Application Data
(60) Provisional application No. 60/406,419, filed on Aug. 28, 2002.

(51) Int. Cl. G01L 19/12

(52) U.S. Cl. 116/70; 116/268

(57) ABSTRACT

A detector for mounting to an air filter provides a signal if the filter is dirty. The detector has a housing mounted to the air filter. The housing has a cavity with a diaphragm. An upstream air inlet leads from an exterior of the housing to an upstream side of the diaphragm. A downstream air inlet leading from the exterior of the housing to a downstream side of the diaphragm. A stationary electrical contact is stationarily mounted in the cavity and normally spaced from the downstream side of the diaphragm. A movable electrical contact is mounted to the downstream side of the diaphragm for movement therewith. An electrical circuit is connected to the electrical contacts, so that movement of the diaphragm due to a sufficient difference in air pressure between the upstream and downstream air inlets causes the contacts to engage each other and causes the electrical circuit to provide a signal.

### RELATED APPLICATION

Applicants claim priority to the invention described herein through a U.S. provisional patent application titled “Filter Clogging Detector,” having U.S. Patent Application Serial No. 60/406,419, which was filed on Aug. 28, 2002, and which is incorporated herein by reference in its entirety.

### FIELD OF THE INVENTION

The present invention relates generally to detectors that detect air pressure differences, more specifically assemblies that are used with filters to alert the user that a filter is becoming clogged.

### BACKGROUND OF THE INVENTION

Houses and many commercial buildings have air conditioning return ducts that contain filters. The filter removes dust and debris from the house prior to entry into the airflow duct. The filters must be periodically changed or cleaned as they become clogged with dust and debris. It is difficult for an occupant to remember to change the filters, which are often hidden from view. If not changed at the appropriate time, the flow of return air is diminished, reducing the efficiency of the air conditioning system.

A number of patents disclose detectors for mounting to the filter. These detectors generally provide an audible warning, such as a whistle, when the filter requires changing. Although shown in patents, to applicants' knowledge, no such devices are currently marketed.

### SUMMARY OF THE INVENTION

In this invention, the detector has a housing that contains a pressure sensitive element that moves in response to a pressure differential between a first position and a second position. A stationary electrical contact is stationarily mounted in the housing. A movable electrical contact is mounted to the pressure sensitive element for movement therewith. The contacts engage each other in one of the positions of the pressure sensitive element and disengage each other in the other position. An electrical circuit is connected to the contacts for sensing a change in the position and providing a signal. The pressure sensitive element blocks any airflow through the housing regardless of the position.

In the preferred embodiment, the pressure sensitive element is a diaphragm, and the movable contact comprises a flexible metallic reed. The stationary contact is a pin that extends to a point closely spaced to the reed. A tube extends upstream from the housing to serve as an air inlet. The tube embeds into the filter.

### BRIEF DESCRIPTION OF THE DRAWINGS

FIG. 1 is a cross-sectional view of a detector assembly constructed in accordance with this invention, shown mounted to a filter and in a first position.

FIG. 2 is an enlarged cross-sectional view of the detector assembly shown in FIG. 1, in which the detector is in a second position.

FIG. 3 is a cross-sectional view of the detector assembly shown in FIG. 1 taken along the line 3-3 of FIG. 2.

### DESCRIPTION OF THE PREFERRED EMBODIMENT

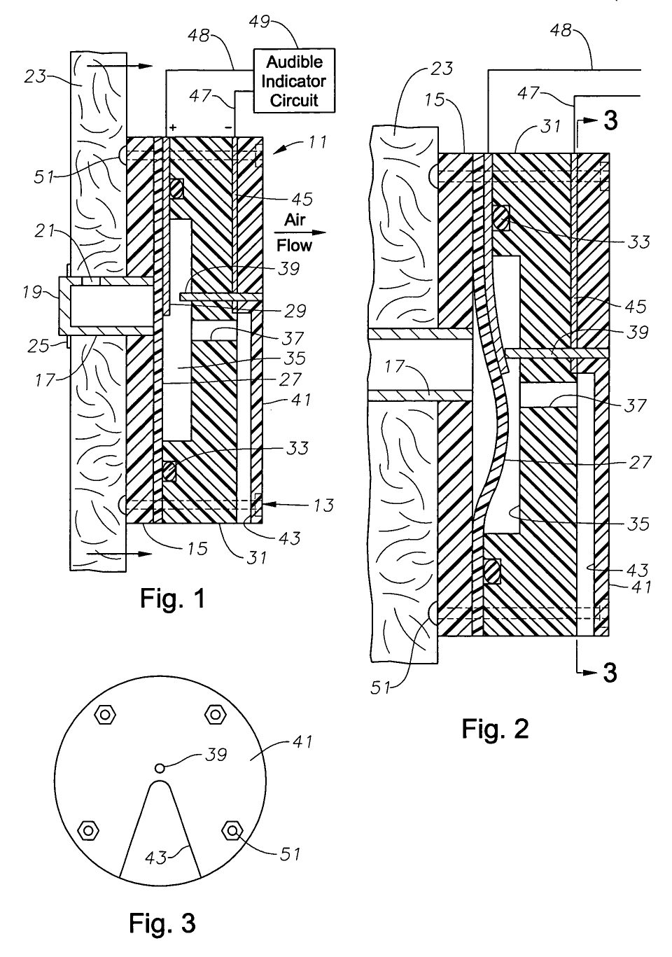

Referring to FIG. 1, detector 11 includes a housing 13. Housing 13 is a circular disc in the preferred embodiment, approximately three inches in diameter. Housing 13 includes an upstream plate 15 of a plastic material that has a small tube 17 protruding from its upstream side. Tube 17 has a closed upstream end 19 and a port 21 in its sidewall. Tube 17 has a length selected to penetrate the thickness of a typical air conditioner filter 23. In this embodiment, upstream end 19 is flush or slightly protrudes past the upstream side of filter 23. Port 21 could be slightly within filter 23 or be slightly upstream of filter 23. Preferably a retainer 25 snaps over tube 17 to serve as part of a means to secure housing 13 to the downstream side of filter 23. Preferably, at least two other tubes or pins (not shown) penetrate filter 23 and have similar retainers 25 to further mount housing 13 to filter 23. Unlike tube 17, the other tubes need not have ports 21 to communicate air to the interior of the tube, because they would serve only as mounting means. Other mounting devices are feasible.

A pressure sensitive element, preferably a diaphragm 27, is mounted to the downstream side of upstream plate 15. Diaphragm 27 is a thin, plastic film, such as polyester with a thickness of 0.001 inch. Diaphragm 27 has its perimeter secured to upstream plate 15, but is otherwise free to flex within its central area. Diaphragm 27 is generally centered over the downstream end of tube 17 in this example and is initially flush with the downstream side of upstream plate 15. Preferably the material of diaphragm 27 is slightly elastic so as to be able to flex slightly without permanent deformation.

A movable electrical contact 29 is mounted to the downstream side of diaphragm 27. Contact 29 is a resilient, flexible, conductive reed, preferably a thin copper strip of about ¼ inch in width. Contact 29 has a free end that is located in a central area of diaphragm 27 and a secured end that is located at the perimeter of diaphragm 27. Contact 29 is preferably laminated onto the downstream side of diaphragm 27 so that its free end will move or flex in unison with movement of diaphragm 27.

Housing 13 also includes a central or main body 31 that has the same diameter as upstream plate 15 but is thicker. Body 31 is also of a plastic material and has an upstream side that abuts flush against an annular periphery of diaphragm 27. An annular seal 33 seals body 31 to diaphragm 27 a short distance inward from its perimeter. Body 31 has a central recess that defines a cavity 35 in conjunction with diaphragm 27. Cavity 35 is preferably circular and located just inward of seal 33. A passage 37 extends from a downstream side of body 31 into cavity 35. Otherwise, cavity 35 is sealed.

A stationary contact 39 protrudes into cavity 35 from the downstream side of body 31. Contact 39 is rigidly secured to body 31 and is preferably a pin. The upstream end of stationary contact 39 is spaced close to the free end of movable contact 29 while diaphragm 27 is in its initial position. FIGS. 1 and 2 exaggerate the initial distance between stationary contact 39 and movable contact 29.

Housing 11 also has a downstream plate 41, which secures flush to the downstream side of body 31. Downstream plate 41 is a disc similar to upstream plate 15, however, in this embodiment, it does not have a tube such as tube 17. Downstream plate 41, however, does have a recess 43 that extends from its periphery to a central area in communication with passage 37. Recess 43 communicates air pressure from a downstream side of filter 23 to passage 37, and thus to cavity 35. In this embodiment, as shown in FIG. 3, recess 43 is pie-shaped. Stationary contact 39 also extends into downstream plate 41 in this embodiment, but is frictionally held by downstream plate 41 and sealed within its hole.

An electrical lead 45 extends within a narrow channel on the downstream side of body 31. Lead 45 has an inner end that is in electrical engagement with stationary contact 39 and an outer end that connects to a wire 47 outside the perimeter of downstream plate 41. Another wire 48 extends from the outer end of movable contact 29, both wires 47, 48 leading to an electrical circuit 49.

Circuit 49 provides a voltage, preferably DC, to wires 47, 48 to provide a potential difference between contacts 29, 39 when they are not engaged. Once engaged, circuit 49 detects that the circuit is closed and provides a signal. Preferably, closing the circuit operates a relay that energizes an audible alarm. Circuit 49 preferably is powered by batteries, however, it could also be supplied with AC, which it converts to DC. In this embodiment, circuit 49 is preferably located in a separate housing (not shown) and installed within the air duct a short distance from housing 13. The housing of circuit 49 may be retained by double-sided tape to the interior of the air duct.

Upstream plate 15, body 31 and downstream plate 41 are secured to each other with a plurality of fasteners 51 spaced around their outer edges. Fasteners 51 cause sealing to occur between upstream plate 15, body 31 and downstream plate 41.

In operation, detector housing 13 is mounted to the downstream side of filter 23 by retainers 25 engaging tube 17 and the other tubes (not shown). The installation may be done by the user or by a manufacturer that sells the filter with the detector 11 installed. Wires 47, 48 may have already been connected between housing 13 and circuit 49, or the user may make the connection. The user places circuit 49 a short distance from filter 23, such as within and on an interior sidewall of the air duct. In the initial position, contacts 29, 39 are spaced apart from each other and diaphragm 27 is located in a plane flush with the downstream side of upstream plate 15.

When the air conditioner or heater blower turns on, air will flow through filter 23 as indicated by the arrows. The upstream air pressure is communicated through tube 17 to the upstream side of diaphragm 27. The air pressure on the downstream side of filter 23 is communicated to cavity 35 and the downstream side of diaphragm 27 by the air inlet comprising recess 43 and passage 37. If the pressures are substantially the same, diaphragm 27 remains in the initial position.

As filter 23 gradually clogs with dust over time, less air can pass through it. Consequently, the air pressure on the downstream side of filter 23 will decrease relative to the air pressure on the upstream side of filter 23. This difference in air pressure will cause the central portion of diaphragm 27 to flex in a downstream direction, as indicated in FIG. 2. The spacing between contacts 29, 39 is selected so that eventually diaphragm 27 and movable contact 29 will flex sufficiently to cause contacts 29, 39 to engage each other. The amount of flexing is exaggerated in FIG. 2, as it preferably is only a few thousandths of an inch between the initial position and the position where contacts 29, 39 engage each other. At this point, the electrical circuit is closed and circuit 49 provides a signal, preferably audible. The signal could be a tone or a pre-recorded message that repeats. Electrical circuit 49 may have a time delay circuit within it to repeat the signal at selected intervals rather than being continuous, so as to avoid depleting its batteries.

The user would then change out filter 23 or if the filter is a permanent type, clean it. If detector 11 is of a disposable type, the new filter may come with one pre-installed. Typically, electrical circuit 49 would be retained and re-used with the new filter, although it could also be made disposable. If detector 11 is to be re-used with a new filter, the user will install it as described above. In the event detector 11 is to be re-used, the flexing of diaphragm 27 is within the elastic range of diaphragm 27 so as to avoid permanently stretching or deforming it. At all times, diaphragm 27 blocks any flow through housing 13 from the upstream to the downstream side.

The invention has significant advantages. The unit accurately detects pressure drops that indicate clogging of the filter. No air is allowed to pass through the housing at any time, thus avoiding any dust entering the air duct. The closed end of the upstream inlet tube avoids dust blocking the communication path. The device is simple in construction and can be made either disposable or re-usable. The unit is operable on batteries, avoiding requiring a nearby electrical outlet. No power is used until the filter has clogged and a signal sent.

While the invention has been shown in only one of its forms, it should be apparent to those skilled in the art that it is not so limited but is susceptible to various changes without departing from the scope of the invention. For example, the contacts could be arranged to engage in the initial position and disengage in the second position. The diaphragm could be a bellows or other piston element that moves axially in response to pressure changes. The movable contact could be a tube or rod that engages the stationary contact in telescoping engagement.

1. A detector for mounting to an air filter, comprising:
a housing adapted to be mounted to the filter;
a pressure responsive element mounted to the housing, the pressure responsive element having an upstream side adapted to be in communication with air pressure on an upstream side of the filter and a downstream side adapted to be in communication with air pressure on a downstream side of the filter, the pressure responsive element being movable in response to a sufficient difference in upstream and downstream pressures from a first position to a second position;
a stationary electrical contact mounted in the housing;
a movable electrical contact mounted to the pressure responsive element, the contacts engaging each other while the pressure responsive element is in one of the positions and disengaging each other while the pressure responsive element is in the other of the positions;
an electrical circuit connected to the contacts for providing a signal when a change in one of the positions occurs; and
wherein the pressure responsive element blocks any flow of air through the housing from an upstream side of the housing to a downstream side of the housing.

2. The detector according to claim 1, further comprising:
a cavity located in the housing, the pressure responsive element being located in the cavity;
an upstream air inlet leading from the upstream side of the housing to the cavity on the upstream side of the pressure responsive element; and
a downstream air inlet leading from the downstream side of the housing to the cavity on the downstream side of the pressure responsive element.

3. The detector according to claim 1, wherein the electrical contacts engage each other when the pressure responsive element is in the second position.

4. The detector according to claim 1, wherein the pressure responsive element comprises a thin, plastic film.

5. The detector according to claim 1, further comprising:
a tube protruding from the upstream side of the housing for communicating air pressure to the pressure responsive element upstream of the filter, the tube adapted to penetrate at least a portion of the filter while the housing abuts the downstream side of the filter.

6. The detector according to claim 1, wherein the tube has a closed upstream end and a sidewall containing a port adjacent the upstream end.

7. A detector for mounting to an air filter, comprising:
a housing adapted to be mounted to an air filter;
a cavity in the housing;
a diaphragm located in the cavity;
an upstream air inlet leading from an upstream side of the housing to an upstream side of the diaphragm, the upstream air inlet being located so as to communicate air pressure on an upstream side of the filter to the upstream side of the diaphragm;
a downstream air inlet leading from a downstream side of the housing to a downstream side of the diaphragm, the downstream air inlet being located so as to communicate air pressure on a downstream side of the filter to the downstream side of the diaphragm;
a stationary electrical contact stationarily mounted in the cavity and normally spaced from the downstream side of the diaphragm;
a movable electrical contact mounted to the downstream side of the diaphragm for movement therewith; and
an electrical circuit connected to the electrical contacts, so that movement of the diaphragm due to a sufficient difference in air pressure between the upstream and downstream air inlets causes the contacts to engage each other and causes the electrical circuit to provide a signal.

8. The detector according to claim 7, wherein the upstream air inlet comprises a tube adapted to penetrate at least a portion of the filter.

9. The detector according to claim 8, wherein the tube has a closed upstream end and an opening along its sidewall adjacent the upstream end to communicate air pressure to the interior of the tube.

10. The detector according to claim 7, wherein the movable electrical contact comprises a flexible metallic strip mounted flush to the downstream side of the diaphragm.

11. The detector according to claim 7, wherein the stationary electrical contact comprises a metallic pin extending through a portion of the housing normal to the diaphragm.

12. The detector according to claim 7, wherein the housing comprises:
a body having a central recess formed therein;
an upstream plate secured to the body over the central recess, defining the cavity, the upstream inlet extending through the upstream plate, the diaphragm having a perimeter mounted to a downstream side of the upstream plate; and
wherein at least a portion of the downstream air inlet extends through the body.

13. The detector according to claim 12, further comprising:
a downstream plate secured to the body opposite the upstream plate, at least a portion of the downstream air inlet being formed in the downstream plate.

14. A method of detecting a condition of an air filter, comprising:
(a) mounting in a housing a movable pressure responsive element, a stationary electrical contact, and a movable electrical contact, the movable contact being mounted to the pressure responsive element for movement between a first position in which the contacts are in disengagement with each other and a second position in engagement with each other; then
(b) mounting the housing to the filter;
(c) flowing air through the filter;
(d) communicating air pressure on an upstream side of the filter to one side of the pressure responsive element, and communicating air pressure on a downstream side of the filter to the other side of the pressure responsive element, and causing the pressure responsive element and the movable contact to move if a difference between the air pressures is sufficient;
(e) once the difference in air pressures reaches a sufficient level, causing the contacts to change from one of the first and second positions to the other of the first and second positions;
(f) monitoring the change in the positions of the contacts with an electrical circuit and providing a signal when the change occurs; and
(g) preventing any air flow from an upstream side to a downstream side of the housing during steps (c)-(f).

15. The method according to claim 14, wherein in step (d), when the sufficient pressure difference occurs, the contacts will move from the first to the second position.

16. The method according to claim 14, wherein the pressure responsive element blocks any air flow from flowing from the upstream side to the downstream side of the housing.
